(19) United States
(12) Patent Application Publication
(10) Pub. No.: US 2006/0078817 A1
(43) Pub. Date: Apr. 13, 2006

(54) Toner processes and compositions thereof

(75) Inventors: Bing R. Hsieh, Webster, NY (US); Richard J. Thompson, Ohiopyle, PA (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Nu-kote International, Inc., a corporation of Delaware

(21) Appl. No.: 10/962,942

(22) Filed: Oct. 12, 2004

(51) Int. Cl. G03G 9/08

(52) U.S. Cl. 430/137.1; 430/105; 430/109.3

(57) ABSTRACT

The invention relates to a process for the preparation of a dry toner powder from an aqueous pigment concentrate dispersion by blending at least an aqueous-based pigment concentrate dispersion and a resin compound to produce a paste; charging the paste to an extruder to generate a hot melt extrusion; dispersing the hot melt extrusion in a mixture of a surfactant and a high boiling organic medium in which the resin compound is substantially insoluble; mixing at elevated temperature and under shear force to form uniform particles of from about 2 microns to about 15 microns particle size; isolating and washing the particles in a low boiling hydrocarbon solvent; and drying and collecting the particles for use as a dry toner powder, and to the dry toner product produced by this process.

The invention relates to a color toner composition for use in developing an electrostatic image by electrophotographic, electrostatic recording and printing processes, and to a process for the preparation thereof.

### BACKGROUND

Present day toners are formulated from a range of potential components. Most toner compositions include at least a polymeric binder material and a colorant. Other commonly used components include black and colored magnetic oxides, charge control agents, internal additives to augment toner properties, such as aiding in deagglomeration and homogeneous distribution of the colorant in the toner composition, and external additives, to aid in the proper function of the toner. The components used in a particular toner formulation are dependent on the requirements of the machine in which the toner is ultimately intended to be used. For instance, the toner formulation must take into account such parameters as image quality, reliability, carrier life, toner shelf life, etc., all of which are intricately involved with the mechanical capability and design of the hardware of the machine. Often, there is more than one component of a toner formulation which performs to eradicate certain undesirable properties of the toner. These same components may however, also contribute to other problems, or the combination of two or more components which affect the same toner properties may result in over-correction of a problematic area in the toner performance. Therefore, the combination of components selected to comprise a given toner composition must be carefully balanced, taking into account the full range of toner performance parameters which may be affected by each component and the interaction of each component with every other component of the toner composition, and the machine and its various components and systems.

Given that each of the foregoing parameters will affect toner performance in some manner, it is unlikely that any one toner will achieve optimum performance in all areas. Therefore, toner producers determine which parameters are most critical to the performance of a toner for a given purpose and which may be compromised, and to what extent.

Toner performance is determined by the combination of components, and by the physical, electrical and chemical properties of each. Such properties include pigment dispersion, particle size, particle size distribution, particle shape, bulk density, mechanical strength, flow properties, triboelectric charge, resistivity, softening point, blocking temperature, melt viscosity, and dispersion. Each of these parameters must be considered for each component in determining what components to combine and how to combine the components to achieve a balanced toner which produces an image having those properties determined to be most important for a specific toner. This choice of components is further influenced by economic and environmental concerns.

The bulk polymeric material of the toner generally functions as the binder for the colorants included in the toner formulation, but also affects many of the other toner functions, such as charging, electrical resistivity, and mechanical integrity, to name a few. Therefore, often times a combination of resins is used to achieve the desired performance. Polymers generally used in toner may be linear, branched or cross linked, and are chosen for their various properties and the manner in which these properties are likely to affect toner performance. For example, certain binder polymer properties affect the thermal performance of the toner. These properties include such binder parameters as glass transition temperature, melt viscosity, blocking temperature, and thermal integrity. In the same manner, the mechanical properties of the binder polymer, including such parameters as impact strength, adhesive/cohesive strength, and surface energy will also affect toner performance. Electrical traits such as triboelectric charge function, resistivity, and dielectric constant, and other miscellaneous features, such as moisture resistivity, % volatility, molecular weight, colorlessness, and pigment compatibility, all have an affect on the ultimate performance level of the toner in which the binder is used.

Among the most popular resins from which the toner resin may be selected are: acrylic resins, epoxy resins, polyamide resins, polyester resins, polyethylene resins, polystyrene resins, styrene-acrylic copolymer resins, and styrene-butadiene resins. As with all toner components, choice of resin is generally determined by the machine parameters and toner performance qualities sought.

Dispersed in the binder resin are the colorants used in the toner formulation. In monocomponent toners, magnetic oxide pigments are used for the purpose of enhancing the magnetic attraction between the toner and the developer roll assembly. Carbon black has historically been the most popular colorant used in black toners, as it strongly influences the triboelectric charging capability of the toner. However, more recent toners employ charge control agents to achieve and control this toner feature, thus allowing the use of more easily dispersed black colorants. The black colorant may also affect the flow characteristics of the toner and, therefore, is sometimes added in incremental amounts to the toner surface.

The charge control agents are also critical in full color printing. The equipment of today allows the reproduction of beautiful, photographic-quality full color images. The printer/copier machines generally employ one or more cartridges that dispense color toner, as well as black toner. The basic color toners used are magenta, cyan and yellow, though any number of other color toners are available. Generally, however, variations in color and tone or shade are produced by the combined printed affect of a basic color set of toners.

Most toner formulations also include any one or more of a number of materials known commonly in the industry as additives. These are generally fine particles that are physically blended with the toner. They may be attached to the toner by electrical means, mechanical means, or by mere physical mixing. These additives may be added to influence flow control, charge control, cleaning, fixing, offset prevention, transfer, conductivity control, humidity sensitivity control, and carrier life stability. Common additive materials include silica, metal oxides, metal stearates, fluoropolymer powders, fine polymer powders, rare earth oxides, waxes, conductive particulates, magnetite, carbon, and titanates. Choice of additives is critical, however, given that many of the additives affect more than a single toner property.

Clearly, given the vast number of components available in the industry for use in toner compositions, and given the propensity for many of the components to enhance some properties and at the same time to deleteriously affect others, choice of components is not a routine matter.

For example, it is known, as was set forth earlier, to produce toner compositions that include pigment colorants. Such compositions may use carbon black. Other color toners may use color pigments commercially available from a number of sources. It is critical to the quality of the printed image that the pigment or colorant used be homogeneously dispersed within the toner particles. This can be difficult to achieve given the propensity of pigment particulates to agglomerate, causing void areas in the toner particles that result in uneven color in the printed image. For this reason, many toner products include dyes instead of pigments. One problem with the use of dyes, however, is the lack of lightfastness and color density of the printed image. In an effort to overcome the problems of pigment dispersion in toner, the pigment has been used in the wet cake form. U.S. Pat. Nos. 5,667,929 and 5,591,552 disclose such a process for toner preparation. In these disclosures, pigment in the wetcake form was added to a mixture of linear polyester and toluene to form a pre-dispersion. The water was flushed, or displaced, by a resin/toluene solution, and then the toluene removed to generate a crushed powder of resin and pigment. While this method does increase pigment dispersion to some degree, printed images using the toner nonetheless exhibit very average print quality.

Therefore, one aspect of concern, and the one of most importance to this invention, is that of pigment dispersion. In an optimum toner, each toner particle will be consistent with respect to performance, and will exhibit a uniform distribution of colorant, charge control agent, additives, etc. The degree to which this uniform dispersion is achieved affects the resulting triboelectric charge, color, yield, and finally the printed image.

An additional concern in toner preparation is that of generating content-uniform particles exhibiting small particle size, at or below about 15 microns, and a narrow particle size distribution. Particle size, and the reduction thereof, is becoming increasingly more critical in toner production processes as newer generations of high resolution printing and copying equipment are developed.

Shape of the particle can be another concern. The more uniform the shape and the smaller the particle size, the better the printed image. Several patents that disclose a means of controlling the shape and particle size of the toner particles include U.S. Pat. Nos. 6,287,742, 6,461,783, 6,531,255 and 6,544,705. In the U.S. Pat. No. 6,287,742, particulate resin, a dry pigment and optionally a charge control agent are combined, and this mixture is melted until the resin is in the molten state. The mixture is dispersed in an organic medium in which the resin is insoluble. A surfactant is also included in the organic medium. Under shear force and elevated temperatures, toner particles exhibiting consistent spherical shape and small size/size distribution are generated. In the U.S. Pat. No. 6,461,783 the resin polymer and dry pigment or dye colorant are combined with a vaporizable plasticizer which is then vaporized off after the mixture is subject to high shear mixing at elevated temperature. The vaporizing of the plasticizer introduces a surface roughness to the toner that aids in performance. While the forgoing achieve good results with respect to toner particle size/size distribution and shape, the disclosures nonetheless fail to address the problem of satisfactory pigment dispersion within the toner particles. The use in these disclosures of conventional or dry pigment, which remains difficult to uniformly disperse even with the processing shown in these patents, results in toners of lesser quality with respect to lightfastness and color density.

One means to achieve homogeneous or uniform pigment dispersion is set forth in U.S. Ser. No. 10/878,860, filed Jun. 28, 2004, to our common assignee, the disclosure of which is incorporated herein by reference. In that disclosure, the pigment colorant is added to the toner composition in the form of an aqueous liquid pigment concentrate dispersion.

The current inventors have determined an alternative means by which to achieve uniform pigment dispersion within toner particles with volume average diameter of less than 15 μm. This is accomplished using an aqueous pigment pre-dispersion in combination with the processing steps set forth herein, to produce a toner suitable for generating a printed image with enhanced brightness of colors, visual density and vividness of color, each of which is a direct result of the quality of the pigment dispersion incorporated into the toner. Further, these toners exhibit narrow charge distribution and narrow particle size distribution.

### SUMMARY OF THE INVENTION

It is therefore an object of the present invention to provide a process for the preparation of a dry toner powder from an aqueous pigment concentrate dispersion, the process comprising: blending at least an aqueous-based pigment concentrate dispersion and a resin compound to produce a paste; charging the paste to an extruder to generate a hot melt extrusion; dispersing the hot melt extrusion in a mixture of a surfactant and a high boiling organic medium in which the resin compound is substantially insoluble; mixing at elevated temperature and under shear force to form particles of from about 2 microns to about 15 microns particle size; isolating and washing the particles in a low boiling hydrocarbon solvent; and drying and collecting the particles for use as a dry toner powder.

It is another object of this invention to provide a process for the preparation of a dry toner powder from an aqueous pigment concentrate dispersion, the process comprising: blending at least an aqueous-based pigment concentrate dispersion and a resin compound to produce a paste; charging the paste to an extruder to generate a hot melt extrusion; dispersing the hot melt extrusion in a mixture of a surfactant and a high boiling organic medium in which the resin compound is substantially insoluble; mixing at elevated temperature and under shear force to form particles of from about 2 microns to about 15 microns particle size; isolating and washing the particles in a low boiling hydrocarbon solvent; and drying and collecting the particles for use as a dry toner powder, the toner powder exhibiting a uniform dispersion of pigment components throughout each toner particle.

These and other objects of the invention will become known to the skilled artisan by reading and practicing the invention as described and set forth in the disclosure which follows.

### BRIEF DESCRIPTION OF THE DRAWINGS

FIG. 1 is a photograph of a hot melt draw-down slide, viewed at 600× magnification, of a toner prepared using an aqueous pigment concentrate dispersion.

FIG. 2 is a photograph of a hot melt draw-down slide, viewed at 600× magnification, of a conventional toner prepared using dry pigment.

### DETAILED DESCRIPTION OF THE INVENTION

The present invention is related to a toner for use in the printing and recording of images by electrophotographic and electrostatic processes. More particularly, the invention relates to the use of specific toner components the use of which results in the production of clear, sharp images in bright, vivid color. In various embodiments of the subject invention, there are provided toners and processes for the production and use thereof wherein the toner composition comprises at least a binder resin and a colorant, and optionally additives, wherein the colorant is an aqueous pigment concentrate dispersion. The process disclosed involves mixing the toner components to generate ribbons of molten toner, and then dispersing the ribbons in a paraffin solvent and mixing under high shear and at elevated temperature, in the presence of a dispersant, to achieve a suspension of toner particles that can then be recovered for use.

The toner composition includes a binder resin that may be selected from any of a number of known resins. Suitable resin components include acrylates, epoxies, ethylene vinyl acetates, polyamides, polyolefins, polystyrenes, styrene acrylates, styrene methacrylates, styrene butadienes, cross linked styrene polymers, polyesters, cross linked polyester epoxies, polyurethanes, vinyl resins, including homopolymers or copolymers of two or more vinyl monomers; and polymeric esterification products of a dicarboxylic acid and a diol comprising diphenol. Vinyl monomers include styrene, p-chlorostyrene, unsaturated mono-olefins such as ethylene, propylene, buytlene, isobutylene, and the like; saturated mono-olefins such as vinyl acetate, vinyl propionate and vinyl butyrate and the like; vinyl esters such as esters of monocarboxylic acids, including methyl acrylate, ethyl acrylate, n-butylacrylate, isobutyl acrylate, dodecyl acrylate, n-octyl acrylate, phenyl acrylate, methyl methacrylate, ethyl methacrylate, and butyl methacrylate and the like; acrylonitrile, methacrylonitrile, acrylamide, mixtures thereof; and the like. Examples of specific thermoplastic toner resins include styrene butadiene copolymers with a styrene content of from about 70 to about 95 weight percent. Additionally, cross linked resins, including polymers, copolymers, and homopolymers of the aforementioned styrene polymers may be selected.

As one suitable type of toner resin, there are selected the esterification products of a di-or poly-carboxylic acid and a diol comprising a diphenol. These resins are illustrated in U.S. Pat. No. 3,590,000, the disclosure of which is incorporated herein by reference. Other specific examples of toner resins include styrene/methacrylate copolymers, and styrene/butadiene copolymers; suspension polymerized styrene butadienes; polyester resins obtained from the reaction of bisphenol A and propylene oxide followed by the reaction of the resulting product with fumaric acid; and branched polyester resins resulting from the reaction of dimethylterphthalate, 1,3-butanediol, 1,2-propanediol, and pentaerythritol, styrene acrylates, and mixtures thereof. Also, waxes with a molecular weight of from about 1,000 to about 7,000, such as polyethylene, polypropylene, paraffin waxes, polyamide waxes and various natural waxes can be included in or on the toner compositions as internal lubricants or fuser roll release agents. Further, reactive extruded polyesters can be selected as the toner resin.

The resin or resins are included in the toner composition disclosed herein in an amount of from about 60% to about 90% of the toner composition. Preferably the resin component is included as from about 60% to about 80% of the total toner composition.

The resin particles may have a Tg of from about 50° C. to about 75° C. and an acid number below 30. The weight average molecular weight for the resin component should preferably be between about 10,000 and about 100,000.

Particularly well suited to practice of the invention are aqueous pigment concentrate dispersions, generally intended for use in liquid ink compositions or paints. Suitable dispersions may contain an aqueous medium into which the desired pigment has been dispersed. The dispersion may further include a surfactant component, or a polymeric pigment stabilizer, such as a water soluble acrylic copolymer. These additional components may be added to stabilize the pigment particles and to improve dispersibility of the pigment during processing. Other possible components of the dispersion include compounds such as propylene glycol, which may be included to enhance the viscosity of the pigment dispersion and to aid in pigment wetting. Suitable aqueous pigment concentrate dispersions in accord with the foregoing include those available commercially from Sun Chemical, such as Aquatone® Dispersions, Flexiverse Dispersions, Sunsperse 6000 Dispersions and Moisture Tone® Dispersions, as well as the dispersions available commercially from Clariant, such as the Hostafine Dispersion products, among others. These dispersions generally include about 30 wt % solids to about 50 wt % solids pigment, and are included as from about 5 wt % to about 30 wt % of the toner composition.

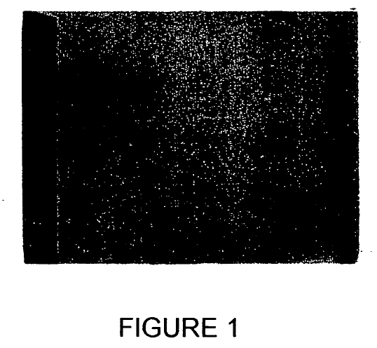

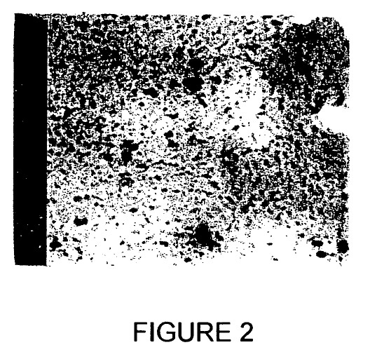

Toners prepared directly from dry pigment exhibit inferior pigment dispersion. FIG. 1 is a photograph of a toner prepared from an aqueous pigment concentrate dispersion. The photo is of a hot melt draw-down of the toner on a glass slide under an optical microscope at 600× magnification. As is shown, the pigment is well dispersed with substantially no agglomeration or void areas present. FIG. 2 is a photograph, prepared in accord with that shown in FIG. 1, except that the toner sample was prepared using dry pigment. The toner in FIG. 2 exhibits poor pigment dispersion, agglomeration and visible void areas. A comparison of these FIGS. 1 and 2 demonstrates clearly the advantage to be gained with regard to pigment dispersion when using an aqueous pigment concentrate dispersion as opposed to dry pigment.

In addition to the aqueous pigment concentrate dispersion, the toner composition may also include other colorants which may be any of the known pigments suitable for use in toner and developer compositions. Though pigments are generally a more preferred colorant because of their light fast properties and the water content, some dye colorants may also be used. These additional colorants may be added to achieve special colors and/or to increase color density. Specifically, the additional colorant should be suitable for use with the recited or suggested resin component, and also compatible with the remaining components of the toner composition. Examples of suitable pigments include carbon black like REGAL 330; magnetites, such as Mobay magnetites M08029, M08060; Columbian magnetites; MAPICO BLACKS and surface treated magnetites; Pfizer magnetites CB4799, CB5300, CB5600, MCX6369; Bayer magnetites, BAYFERROX 8600, 8610; Northern Pigments magnetites, NP-604, NP-608; Magnox magnetites TMB-100, or TMB-104; and the like. As color pigments, there can be selected cyan, magenta, yellow, red, green, brown, or blue pigments or mixtures thereof. Specific examples of pigments include phthalocyanine HELIOGEN BLUE L6900, D6840, D7080, D7020, PYLAM OIL BLUE, PYLAM OIL YELLOW, PIGMENT BLUE 1 available from Paul Uhlich & Company, Inc., PIGMENT VIOLET 1, PIGMENT RED 48, LEMON CHROME YELLOW DCC 1026, E.D. TOLUIDINE RED and BON RED C available from Dominion Color Corporation, Ltd., Toronto, Ontario, NOVAPERM YELLOW FGL, HOSTAPERM PINK E from Hoechst, CINQUASIA MAGENTA available from E. I. DuPont de Nemours & Company, and the like. Generally, colored pigments that can be selected are cyan, magenta, or yellow pigments, and mixtures thereof. Examples of magenta materials that may be selected as pigments include, for example, 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyan materials that may be used as pigments include copper tetra(octadecyl sulfonamido) phthalocyanine, x-copper phthalocyanine pigment listed in the Color Index as CI 74160, CI Pigment Blue, and Anthrathrene Blue, identified in the Color Index as CI 69810, Special Blue X-2137, and the like; while illustrative examples of yellow pigments that may be selected are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33, 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK, and cyan components may also be selected as pigments with the process of the present invention. These pigments may be used as dry powder or in the wet cake form. The pigment component should be included in the toner composition in an amount of from about 0 wt % to about 8 wt %, and preferably from about 0 wt % to about 5 wt % of the toner composition.

Charge control agents are added to a toner for the purpose of making the toner product either more electronegative or more electropositive. Whether the toner needs to be made more electronegative or more electropositive is determined by several factors. Some of these include the electronegativity of the remaining toner components as combined, i.e., different colorants and resins may impart different charge characteristics to the toner composition. Also, the carrier, if one will be used, must be considered, as many carrier materials impart a charge to the toner composition. Further, the machine in which the toner is used may impart some charge to the toner, as will the operation thereof. The purpose of the charge control agent component of the toner is to stabilize the toner with respect to electrical charge and thus avoid problems of print quality, color balance, and fogging, which are associated with too much or too little charge on the toner particles. Charge control agents may be selected from quaternary salts, metal and non-metal dyes, chromium, cobalt and zinc complexes, nigrosines, positive and negative colorless polymers, metal chelates, and quaternary amines, depending on the particular requirements of the complete toner composition.

Examples of suitable commercially available charge control agents include the following: S-34, S-40, E-82, E-81, E-84, E-87, E-88 and E-89, all manufactured by Orient Chemicals, and TRH, T-77, T-95, and TNS-2, all manufactured by Hodogaya Chemical Co. Charge control agents offered by BASF, Hoechst/Clariant, Zeneca and others may also be found to be suitable. These and other similar commercially available charge control agents may be selected. Generally, the charge control agent is included in the toner composition as up to about 10% thereof, based on the weight of the toner.

The wax component to be used in the toner- is preferably composed of at least one wax selected from the group consisting of polyolefin waxes, carnauba wax, candelilla wax, hydrogenated jojoba oil, rice wax, hydrogenated lanolin, meadowfoam oil, and derivatives thereof. Preferably, the polyolefin waxes include low molecular weight waxes such as polypropylenes and polyethylenes, such as EPOLENE N-15 commercially available from Eastman Chemical Products, Inc., and similar waxes. The commercially available polyethylenes may have a molecular weight of from about 1,000 g/mol to about 1,500 g/mol, while the commercially available polypropylenes utilized for the toner compositions of the present invention may have a molecular weight of from about 4,000 g/mol to about 7,000 g/mol.

Low molecular weight wax materials are present in the toner composition of the present invention in various amounts, however, generally these waxes are present in the toner composition in an amount of from about 0 wt % to about 15 wt %, and preferably in an amount of from about 0 wt % to about 10 wt %, based on the weight of the toner.

Useful plasticizers include both very low viscosity plasticizers and polymeric plasticizers that are liquid at room temperature. These low viscosity plasticizers can be used alone or as part of a mixture of low viscosity plasticizers. Typical examples of useful plasticizers include dimethylphthalate, dibutylphthalate, tributylphosphate, butylstearate, ethyleneglycolbutyletheracetate, diethyleneglycolethyletheracetate, and diethyleneglycolbutyletheracetate. The amount of plasticier included in the toner is preferably from about 0 wt % to about 5 wt %, based on the toner composition.

The toner of the present invention may further include external additives employed for the purpose of enhancing flowability of the toner product. The additive used may be a single component additive or may be a specific combination of additives, the combined use of which produces a special performance effect of the toner product. Additives may be selected from silicas, metal stearates, fluoropolymer powders, fine polymer powders, rare earth oxides, waxes, conductive particles, magnetite, carbon, and titanates, and other like compounds.

Post additive treatment agents, such as flowability enhancers of the type used in this toner product, result in deagglomeration of the toner particles in use, and enhanced stability during storage of the toner product. In selecting a flowability enhancing additive to be added to the toner product during a post-treatment step, it is important to consider these parameters: anti-caking; flowability; electrostatic charge; stability; coefficient of friction; transfer efficiency; photoreceptor release properties; hydrophobicity; storage stability; and others. The indication of these characteristics generally requires inorganic compounds of fine particle size and high surface areas. These additives are often treated to render them hydrophobic in order to overcome the drawbacks associated with their conventionally hydrophillic nature.

For example, as the post additive to be employed in production of a toner in keeping with the present invention there may be used a hydrophobic silica fine powder in combination with a hydrophobic titanium oxide powder. Preferably, the titanium oxide powder is a silane treated powder. Other suitable external additives, or post additives, may include but are not limited to the use of aluminum oxide; zinc oxide; cerium oxide; strontium titanate; iron oxide; ferrite powder; calcium carbonate; copper oxide; barium sulfate; lithopone; metal salts of fatty acids; powdered fluoropolymers; polytetrafluoroethylene; polyethylene powder; carbon black; silicon carbide; silicon nitride; and powdered or fine particle polymers.

As an example of a toner formulation in accord with the claimed invention, provided hereinafter is processing information and toner formulations representative of one embodiment of the toner compositions.

For each of the following toner compositions, aqueous pigment concentrate dispersions commercially available from Sun Chemical were used. The dispersions are generally intended for use in liquid ink compositions and paints. Each dispersion included an aqueous base into which had been dispersed the desired pigment and a small amount of acrylic polymer, which functions as a pigment stabilizer. No surfactants are included in the dispersions used in the following examples, though other dispersions including surfactants would be expected to generate similar results. Each dispersion exhibited pigment concentration of about 30 wt % solids to about 50 wt % solids.

For each toner composition according to this invention, the aqueous pigment concentrate dispersion of the appropriate color was added to a high intensity mixer along with the remaining toner components, including resin, wax, charge control agent, additional pigment and plasticizer. The components were blended for about 10 to about 30 minutes at a speed of about 1000 to about 3000 RPM to create a paste.

The resulting paste, including the resin, wax, charge control agent, pigment, plasticizer and about 12 wt % water, from the aqueous pigment concentrate dispersion, was then transferred to a twin screw extruder and compounded at 150° C., at 400 RPM and at about 64% torque to drive off the water and to achieve a higher degree of pigment dispersion. Ribbons of molten toner were then extracted from the extruder.

The ribbons of molten toner were then added to a reactor, along with paraffin solvents, at a temperature of from about 100° C. to about 200° C., and subjected to high shear mixing in the presence of a dispersant. The weight ratio of the toner ribbons to the paraffin solvents was in the range of 20:80 to 80:20. The dispersant is added from about 5 wt % to about 20 wt %, based on the weight of the toner ribbons. The amount of dispersant used and the shear force employed are important parameters with regard to controlling the particle size of the resulting toner. The particle size is generally inversely proportional to the amount of dispersant, or surfactant (these terms are used interchangeably herein with regard to this component) used and the shear force. The high shear mixing, at elevated temperature, was continued until a suitable suspension of toner in the desired size range was obtained. This range is generally from about 2 μm to about 15 μm, preferably from about 2μ to about 10 μm.

Any suitable mixing equipment may be employed for the particle formation step. An example of such equipment is a vessel equipped with an impeller-type agitator and a means of heating the content of the vessel. During the step of dispersing the toner ribbons, the organic solvent is maintained at an elevated temperature. The temperature selected should ensure fluid-like behavior of the resin composition. While any suitable elevated temperature may be employed, preferred temperatures are in the range of at least about 100° C. to about 200° C. Effective formation of the dispersion as well as successful comminution requires that the solubility parameter of the organic medium be generally different from the solubility parameter of the resin component by at least about 1. In preferred embodiments the solubility parameter of the organic medium is larger or smaller than the solubility parameter of the resin component by at least about 2. Any suitable organic medium which does not dissolve the resin component may be employed. Particularly preferred solvents include paraffin solvents and poly (ethylene glycol). Preferably, paraffin solvents may be selected from linear or branched chain aliphatic hydrocarbons. A nonpolar liquid of the ISOPAR® series (Exxon Corporation), NORPAR® series (Exxon Corporation), the SOLTROL® series (Phillips Petroleum Company), and the SHELLSOL® series (Shell Oil Company), and other similar solvents can be used for the present invention. These hydrocarbon liquids are considered narrow portions of isoparaffinic hydrocarbon fractions exhibiting a boiling point in the range of 150-300° C.

The organic medium typically further includes a surfactant which may be a non-ionic, a cationic or an anionic surfactant. Preferred examples of such surfactants include copolymers of vinylpyrrolidonone, alkylated maleic acid copolymers, polymers containing ethylene oxide moieties, polymers containing propylene oxide moieties and sodium dodecylsulfate. The surfactant may be present in the organic medium in an amount of from about 0.2 wt % to about 15 wt %, based on the amount of solvent present, while from about 1 wt % to about 10 wt % based on the amount of solvent present is typical.

Upon achieving a suspension of toner particles in the desired size range, the suspension was allowed to cool, either at ambient temperature or by immersion in cold water, and the toner particles were recovered by filtration. The particles were further washed with a low boiling hydrocarbon solvent to remove the paraffin solvents, and then vacuum dried, leaving dry color toner powder.

The mean particle size by volume of a toner in keeping with this processing may range from about 3 microns to about 15 microns, as measured on a Coulter Multisizer, depending upon the application and the requirements of the imaging machine in which the toner will be used. The resulting fine powder toner was passed through an Air Classifier to selectively remove the ultra-fine particles, usually those of 5 microns or smaller, which may be detrimental to the xerographic imaging process.

The toner powder thus produced was then post treated by blending the powder, in a Henschel High Intensity Blender, with a combination of post additives, in this instance hydrophobic silane treated silica fine powder and hydrophobic silane treated titanium oxide powder. Of course, a single post additive agent may also be used. The skilled artisan will be able to determine what post additive or post additive combination will best suit the intended toner product. Treatment with the post additives produced a toner powder with optimum flow properties for use in the intended printer/copier machine.

### EXAMPLE 1

In this Example 1, cyan color toner ribbons were prepared in accord with the foregoing process parameters. The aqueous pigment concentrate dispersion used was BFD-1121 Pigment Blue, available commercially from Sun Chemical. The pigment dispersion was in liquid form and contained 30.8% pigment, 60% water and 9.2% acrylic polymer pigment stabilizer. The toner ribbon contained 9.5% by weight of this dispersion. The binder resin used in this toner was a styrene butyl acrylate copolymer resin, and was added in an amount of 79% by weight of the composition. Additional dry pigment concentrate was also added. Keystone Blue GN pigment, available commercially from Keystone Aniline Corp., was added as 4.5 wt % of the formulation. The charge control agent, used as 2.0 wt % of the composition, comprised Bontrol E-84, available commercially from Orient Chemicals. In addition to the foregoing, the composition included 4 wt % of Ceralub P-40 polypropylene wax, available commercially from Shamrock Technologies, Inc., and 1 wt % Cabosil M-5 silica fine powder, available commercially from Cabot Corporation. In this Example no plasticizer was used. The foregoing components were blended in a Henschel High Intensity Mixer for ten (10) minutes at a speed of 2,000 RPM. The resulting blend was then transferred to a Warner & Pfleiderer ZSK-30 twin screw extruder and compounded at 150° C. at 400 RPM and at about 64% torque. Ribbons of cyan toner were extruded and collected.

### EXAMPLE 2

The yellow toner ribbons of this example were prepared in accord with the processing described above as Example 1, except that 11.5 wt % of a yellow aqueous pigment concentrate dispersion, YFD-4249 Pigment Yellow 17 dispersion, available commercially from Sun Chemical, was used in place of the cyan pigment dispersion of that example. This yellow pigment dispersion contained pigment, water and acrylic polymer pigment stabilizer. Also, 4.5 wt % dry pigment concentrate Clarient Permanent Yellow GG Pigment Yellow 17 was used in place of the Keystone Blue Pigment of Example 1. The remaining components used in this Example 2 were: 77 wt % styrene butyl acrylate copolymer resin; 4 wt % Ceralub P-40 polypropylene wax; 2 wt % zinc salicylic acid charge control agent; and 1 wt % Cabosil M-5 silica fine powder, available commercially from Cabot Corporation. This mixture was mixed in a Henschel High Intensity Mixer for ten (10) minutes at a speed of 2,000 RPM. The resulting blend was then transferred to a Warner & Pfleiderer ZSK-30 twin screw extruder and was compounded at 150° C. at 400 RPM and at about 64% torque to generate ribbons of yellow toner.

### EXAMPLE 3

In Example 3, magenta toner ribbons were prepared in accord with the processing of Example 1, but differed in that the following were used: 21 wt % of magenta aqueous pigment concentrate QFD-1146 Pigment Red 122 dispersion from Sun Chemicals, comprising pigment, water and acrylic polymer pigment stabilizer; 4.0 wt % of dry pigment concentrate, Clarient HostaCopy M-501 Pigment Red 122; 69 wt % styrene butyl acrylate copolymer resin; 4.0 wt % Cerabub P-40 polypropylene wax; and 2.0 wt % zinc salicylic acid charge control agent. This mixture was mixed in a Henschel High Intensity Mixer for ten (10) minutes at a speed of 2,000 RPM. The resulting blend was then transferred to a Warner & Pfleiderer ZSK-30 twin screw extruder and was compounded at 150° C. at 400 RPM and at about 64% torque to generate ribbons of magenta toner.

The molten ribbons prepared in Examples 1 through 3 may be used to generate toner powder.

### EXAMPLE 4

The toner ribbons from any of Examples 1-3 may be used to illustrate the particle formation process. To begin, about 200 g of toner ribbons, about 200 g of a 1:1 mixture of Isopar-L and Isopar-V paraffin solvents, available from Exxon Chemical Company, and about 20 g of Ganex V220 dispersant, available from ISP Corporation, Wayne, N.J. may be charged into a reaction flask equipped with a mechanical stirring impeller and a reflux condenser. The mixture should then be heated to 150° C. and then stirred under increased shear force of 400 rpm. Heating and shearing should be continued until a particle size of about 8 microns is achieved. Upon cooling, the toner particles may be separated from the organic medium by filtration, and the entrained organic medium in the filter cake removed by re-dispersing the filter cake in hexanes and re-filtering three (3) times. The washed powder can be dried to give dry toner particles consistent with the color of the original toner ribbons.

The advantages for a toner prepared from an aqueous pigment concentrate dispersion over that prepared from a dry pigment include a higher degree of pigment dispersion, a higher color density at an equal pigment loading, a reduced pigment loading at a desired color density, narrower particle size distribution and charge distribution. A reduced pigment loading is advantageous in reducing the amount of pigment exposed on the surface of a toner particle and thus narrowing the charge distribution. A reduced pigment loading should reduce fine particles of less than 3 microns and thus narrow the particle size distribution. A higher degree of pigment dispersion becomes critical for the preparation of smaller size toner particles (5-8 microns) which are needed for the new generation of high resolution laser printers and copiers. The use of an aqueous pigment concentrate dispersion becomes the method of choice for achieving the smaller size toner particles that show high color density, narrow charge distribution and particle size distribution.

The invention contemplated by this disclosure includes color toner formulations prepared using an aqueous, liquid state, pigment concentrate dispersion containing about 30% solids to about 50% solids. The invention is shown to be well suited to the preparation of a full color set of toners, including magenta, cyan and yellow toners. It is to be understood that the inventive aspects of the formulation as presented herein are equally applicable to all color toner formulations, and it is intended that the invention should be construed in keeping with and afforded the full breadth of coverage of the appended claims.

Having thus described the invention, we claim:

1. A process for the preparation of a dry toner powder from an aqueous pigment concentrate dispersion, the process comprising: blending at least an aqueous-based pigment concentrate dispersion and a resin compound to produce a paste; charging the paste to an extruder to generate a hot melt extrusion; dispersing the hot melt extrusion in a mixture of a surfactant and a high boiling organic medium in which the resin compound is substantially insoluble; mixing at elevated temperature and under shear force to form particles of from about 2 microns to about 15 microns particle size; isolating and washing the particles in a low boiling hydrocarbon solvent; and drying and collecting the particles for use as a dry toner powder.

2. The process of claim 1 wherein the step of generating the hot melt extrusion drives off substantially all of the water content from the aqueous-based pigment concentrate dispersion.

3. The process of claim 1 wherein the blend containing at least the aqueous-based pigment concentrate dispersion and the resin compound further contains up to about 15 wt % of a wax component.

4. The process of claim 3 wherein the wax component is a low molecular weight wax selected from the group consisting of polyolefin waxes, carnauba wax, candelilla wax, hydrogenated jojoba oil, rice wax, hydrogenated lanolin, meadowfoam oil, and derivatives thereof.

5. The process of claim 1 wherein the blend containing at least the aqueous-based pigment concentrate dispersion and the resin compound further contains up to about 8 wt % of an additional colorant.

6. The process of claim 4 wherein the additional colorant is a dry pigment.

7. The process of claim 1 wherein the blend containing at least the aqueous-based pigment concentrate dispersion and the resin compound further contains up to about 10 wt % of a charge control agent.

8. The process of claim 7 wherein the charge control agent is selected from the group consisting of quaternary salts, metal and non-metal dyes, chromium, cobalt and zinc complexes, nigrosines, positive and negative colorless polymers, metal chelates, and quaternary amines.

9. The process of claim 1 wherein the blend containing at least the aqueous-based pigment concentrate dispersion and the resin compound further contains up to about 5% wt of a plasticizer.

10. The process of claim 9 wherein the plasticizer is a low viscosity plasticizer that is liquid at room temperature.

11. A dry toner powder prepared from an aqueous pigment concentrate dispersion, the toner powder comprising small particles of from about 2 microns to about 15 microns particle size and having pigment uniformly dispersed therein, the toner powder having been produced from a mixture of at least a resin and an aqueous pigment concentrate dispersion, wherein the pigment concentrate dispersion exhibits a % solids of from about 30% to about 50%, and wherein the aqueous pigment concentrate dispersion and the resin have been mixed under shear force at elevated temperature to produce a hot melt extrusion, the extrusion then being further dispersed in an organic medium in which the resin is substantially insoluble, and wherein the resin and the organic medium exhibit solubility parameters with a difference therebetween of at least about 1.

12. The dry toner powder of claim 11 wherein the aqueous pigment concentrate dispersion further contains a pigment stabilizer.

13. The dry toner powder of claim 11 wherein the aqueous pigment concentrate dispersion further contains a surfactant.

14. The dry toner powder of claim 11 wherein the difference in solubility parameter between the resin and the organic medium is at least about 2.

15. The dry toner powder of claim 14 wherein the weight ratio of the hot melt extrusion to the organic medium is from about 20:80 to about 80:20.

16. The dry toner powder of claim 11 wherein the organic medium further includes from about 0.2% to about 5% of a surfactant, based on the weight of the organic medium.
